(19) United States
(12) Patent Application Publication
(10) Pub. No.: US 2015/0117536 A1
(43) Pub. Date: Apr. 30, 2015

(54) VIDEO DECODER TECHNIQUES

(71) Applicant: Nvidia Corporation, Santa Clara, CA (US)

(72) Inventors: Xinyang YU, Shanghai (CN); Olivier LAPICQUE, San Jose, CA (US); Xiaohua YANG, San Jose, CA (US); Jincheng LI, Cupertino, CA (US); Manindra PARHY, Fremont, CA (US)

(73) Assignee: Nvidia Corporation, Santa Clara, CA (US)

(21) Appl. No.: 14/067,698

(22) Filed: Oct. 30, 2013

(51) Int. Cl. H04N 19/44; H04N 19/583

(52) U.S. Cl. CPC H04N 19/00533; H04N 19/00733
USPC 375/240.16

(57) ABSTRACT

AVC decoding techniques include parsing a set of alternating slices of one or more picture frames and parsing another set of alternating slices of the one or more picture frames. The parsed set of alternating slices of the one or more picture frames are buffered separately from the parsed other set of alternating slices of the one or more picture frames. The buffered parsed set of alternating slices and the other buffered parsed set of alternating slices are alternating decoded.

### BACKGROUND OF THE INVENTION

Computing systems have made significant contributions toward the advancement of modern society and are utilized in a number of applications to achieve advantageous results. Numerous devices, such as desktop personal computers (PCs), laptop PCs, tablet PCs, netbooks, smart phones, servers, and the like have facilitated increased productivity and reduced costs in communicating and analyzing data in most areas of entertainment, education, business, and science. One common aspect of conventional computing, devices is the encoding and decoding of audio/video content.

In conventional audio/video encoders and decoders the data stream typically is processed by a number of processing stages. Some stages operate serially on various divisions/grouping of the hit streams, while other stages can operate on the bit stream in a parallel manner. In one or more processing stages, there is typically a high data dependence in the audio/video bit stream that cause one or more processing stages to be a bottleneck in the audio/video encoding and/or decoding process. Accordingly, there is a continuing need for improved audio/video encoding and/or decoding techniques.

### SUMMARY OF THE INVENTION

The present technology may best be understood by referring to the following description and accompanying drawings that are used to illustrate embodiments of the present technology directed toward Advanced Video Coding (AVC) decoding techniques.

In one embodiment, an AVC decoder includes a plurality of parsers, a plurality of parser buffers, and a decoder. Each parser buffer is communicatively coupled to a respective parser. Each parser parses a set of alternating slices of one or more frames of audio/video data, Each parser buffer buffers the set of alternating slices of the one or more frames of audio/video data from a respective one of the plurality of parsers. The decoder decodes the parsed slices of one or more frames of audio/video data alternatingly from the plurality of parser buffers.

In another embodiment, AVC decoding includes parsing a set of alternating slices of one or more picture frames. The other set of alternating slices of the one or more picture frames are parsed separately from the set of alternating slices. The parsed other set of alternating slices are buffered separately from the parsed set of alternating slices. The buffered parsed slices are alternatingly decoded from the buffered parsed set of alternating slices and the buffered parsed other set of alternating slices.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Embodiments of the present technology are illustrated by way of example and not by way of limitation, in the figures of the accompanying drawings and in which like reference numerals refer to similar elements and in which:

FIG. 1 shows a block diagram of an Advanced Video Coding (AVC) decoder, in accordance with one embodiment of the present technology.

FIG. 2 shows another block diagram of the AVC decoder, in accordance with one embodiment of the present technology.

FIG. 3 shows a block diagram of macroblock level decoding for the AVC decoder, in accordance with the conventional art.

FIG. 4 shows a block diagram of picture level decoding for the AVC decoder, in accordance with the conventional art.

FIG. 5 shows a block diagram of picture level decoding for the AVC decoder, in accordance with the conventional art.

FIG. 6 shows a flow diagram of slice decoding, in accordance with one embodiment of the present technology.

FIG. 7 shows an exemplary schedule of slice level decoding during a picture frame, in accordance with one embodiment of the present technology.

FIG. 8 shows an exemplary schedule of slice level decoding among picture frames, in accordance with one embodiment of the present technology.

### DETAILED DESCRIPTION OF THE INVENTION

Reference will now be made in detail to the embodiments of the present technology, examples of which are illustrated in the accompanying drawings. While the present technology will be described in conjunction with these embodiments, it will be understood that they are not intended to limit the invention to these embodiments. On the contrary, the invention is intended to cover alternatives, modifications and equivalents, which may be included within the scope of the invention as defined by the appended claims. Furthermore, in the following detailed description of the present technology, numerous specific details are set forth in order to provide a thorough understanding of the present technology. However, it is understood that the present technology may be practiced without these specific details. In other instances, well-known methods, procedures, components, and circuits have not been described in detail as not to unnecessarily obscure aspects of the present technology.

Some embodiments of the present technology which follow are presented in terms of routines, modules, logic blocks, and other symbolic representations of operations on data within one or more electronic devices. The descriptions and representations are the means used by those skilled in the art to most effectively convey the substance of their work to others skilled in the art. A routine, module, logic block and/or the like, is herein, and generally, conceived to be a self-consistent sequence of processes or instructions leading to a desired result. The processes are those including physical manipulations of physical quantities. Usually, though not necessarily, these physical manipulations take the form of electric or magnetic signals capable of being stored, transferred, compared and otherwise manipulated in an electronic device. For reasons of convenience, and with reference to common usage, these signals are referred to as data, bits, values, elements, symbols, characters, terms, numbers, strings, and/or the like with reference to embodiments of the present technology.

It should be borne in mind, however, that all of these terms are to be interpreted as referencing physical manipulations and quantities and are merely convenient labels and are to be interpreted further in view of terms commonly used in the art. Unless specifically stated otherwise as apparent from the following discussion, it is understood that through discussions of the present technology, discussions utilizing the terms such as “receiving,” and/or the like, refer to the actions and processes of an electronic device such as an electronic computing device that manipulates and transforms data. The data is represented as physical (e.g., electronic) quantities within the electronic device's logic circuits, registers, memories and/or the like, and is transformed into other data similarly represented as physical quantities within the electronic device.

In this application, the use of the disjunctive is intended to include the conjunctive. The use of definite or indefinite articles is not intended to indicate cardinality. In particular, a reference to “the” object or “a” object is intended to denote also one of a possible plurality of such objects. It is also to be understood that the phraseology and terminology used herein is for the purpose of description and should not be regarded as limiting.

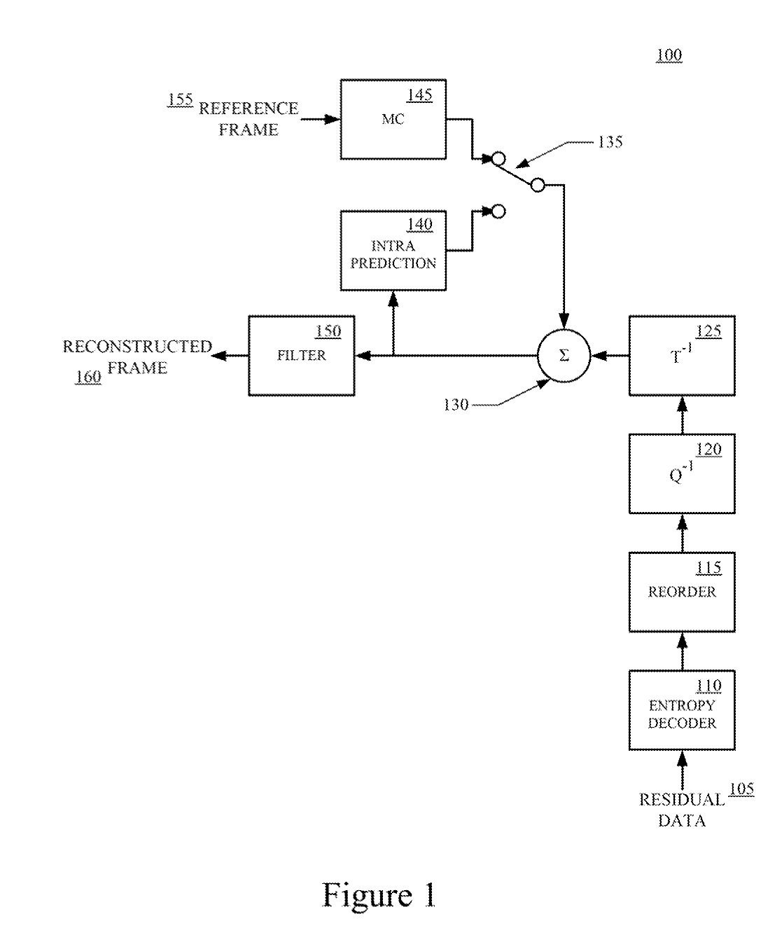

Referring to FIG. 1, a block diagram of an Advanced Video Coding (AVC) decoder, in accordance with one embodiment of the present technology, is shown. The AVC decoder, in one embodiment, is a block-oriented motion compensation-based decoder compliant to the H.264/MPEG-4 AVC standard. The H.264/MPEG-4 AVC compliant bit stream is typically arranged in frames of picture data, the frames are further typically divided into slices, and the slices are divided into blocks and/or macroblocks. A slice is a construct of macroblocks. Usually in 1080p H.264 video content, a picture contains four (4) slices.

The AVC decoder includes an entropy decoder block 110, a reordering block 115, an inverse quantizer block 120, an inverse transform block 125, an adder block 130, switching block 135, an intra prediction block 140, a motion compensation block 145, and filter block 150. Each 4×4 block of residual data 105 is entropy decoded 110. After reordering 115, inverse quantization 120, and inverse transform 125, the decoder adds 130 each group of 4×4 residual data with the predicted pixel values of inter prediction 140 or intra prediction 145 to reconstruct the 4×4 block 160, in accordance with the switching block 135, from one or more reference frames 155 and the network abstraction layer (NAL) residual data 105. One or more previously encoded frames 155 may be utilized by the motion compensation block 145 to generate the inter prediction values. The macroblock is reconstructed by combining the reconstructed macroblock row by row, and the decoder 100 can obtain the reconstructed frame after performing loopfiltering 150.

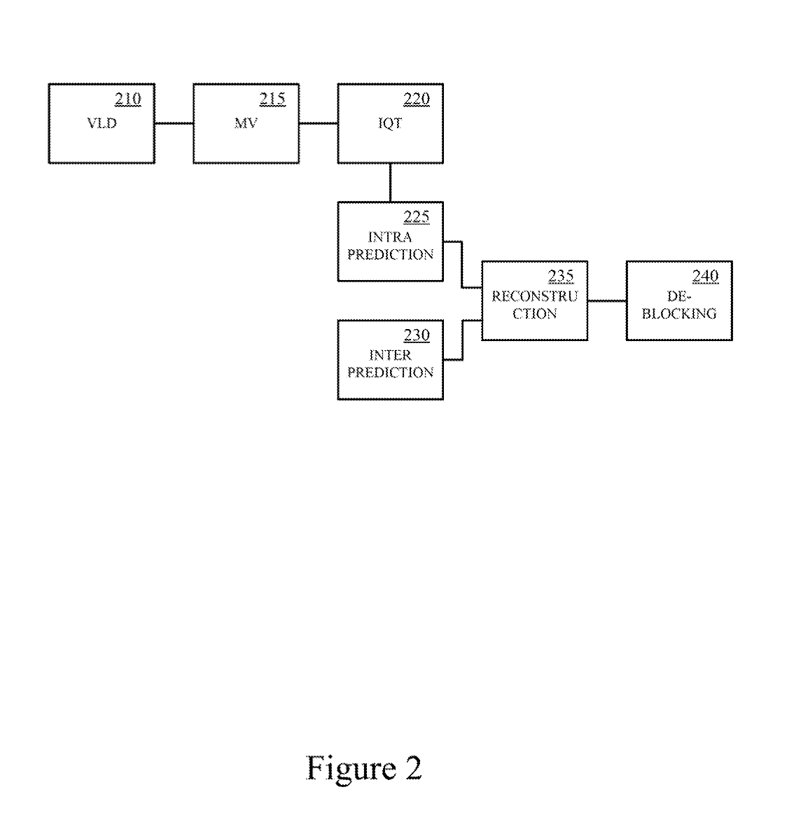

Referring now to FIG. 2, another block diagram of the AVC decoder, in accordance with one embodiment of the present technology, is shown. The AVC decoder includes an entropy decoding module (VLD) 210, a motion vector (MV) module 215, an inverse quantizing and transform module (IQT) 220, an intra prediction module 225, and inter prediction module 230, a reconstruction module 235 and deblocking module 240. The entropy decoding module (VLD) 210 performs entropy decoding of the NAL residual data. The (MV) module 215 decodes the intra/inter prediction mode and decodes some control information for deblocking and the like. The inverse quantizing and transform module (IQT) 220 does inverse quantize and transform functions. The intra prediction module 225 performs intra prediction. The inter prediction module 230 performs inter prediction, which may include motion compensation. The reconstruction module 235 reconstructs the decoded macroblock. The deblocking module 240 performs the deblocking process.

The processes of the entropy decoding module 210 and MV module 215 have a strong data dependency. As a result of the strong data dependency, the decoding order is serial in a slice. However, the other modules can be treated as parallel. In the conventional art, most entropy decoder modules are the decoding bottleneck when decoding high bitrate video content.

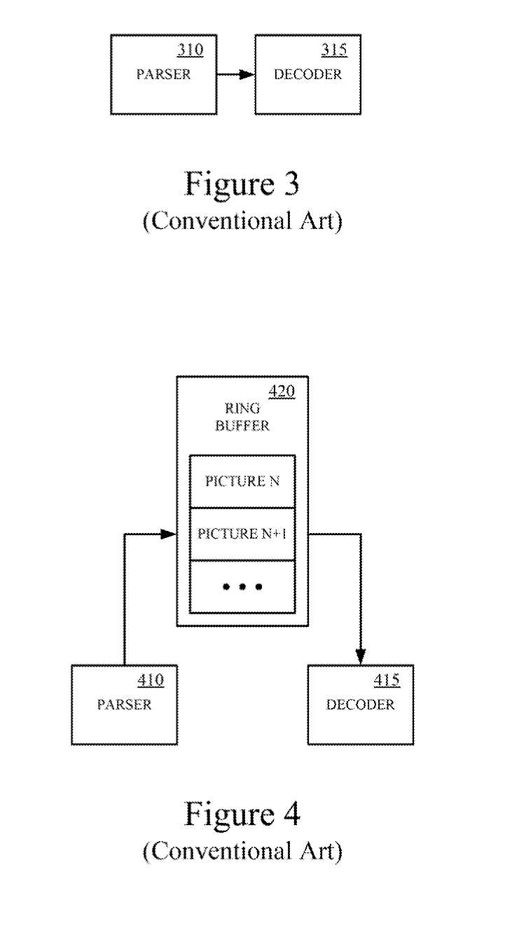

To simplify the description, we refer to the entropy decoder (VLD) module 210, and optionally the MV module 215 as the parser stage, while the other modules 215-235 are referred to as the decoder stage. Referring now to FIG. 3, a block diagram of macroblock level decoding for the AVC decoder, in accordance with the conventional art, is shown. The macroblock based decoder includes a parser stage 310 and a decoder stage 315. The parser stage 310 or the decoder stage 315 includes an internal first-in-first-out (FIFO) buffer which can hold several macroblocks of depth data between the parser stage 310 and the decoder stage 315. In this architecture, the decoder stage 315 processes data a macroblock to several macroblocks behind the parser stage 310.

Referring now to FIG. 4, a block diagram of picture level decoding for the AVC decoder, in accordance with the conventional art, is shown. The decoder includes a parser stage 410, a decoder stage 415 and an external ring buffer 420. The ring buffer 420 can hold several pictures of depth data between the parser stage 410 and the decoder stage 415. In this architecture, the decoder stage 415 processes data on a macroblock to several pictures behind the parser stage 410. In both the macroblock level and picture level decoding architectures, the parser 310, 410 is usually a bottleneck in high bitrate streams.

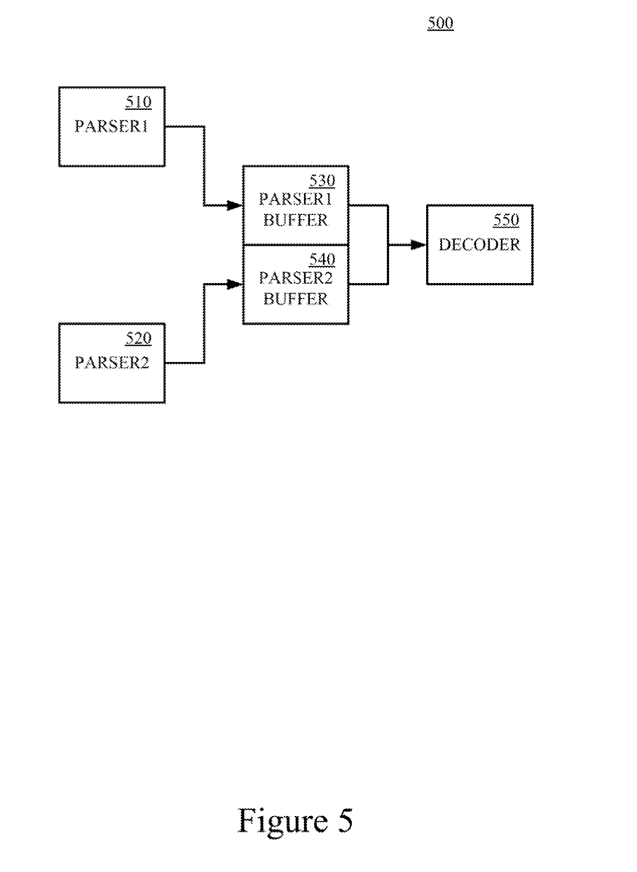

Referring now to FIG. 5, a block diagram of slice level decoding for the AVC decoder 500, in accordance with one embodiment of the present technology, is shown. The slice level decoding is a parallel parser video decoding architecture. The AVC decoder 500 includes a first and second parser 510, 520, a first and second parser buffer 530, 540, and a decoder 550. The first and second parser buffers 530, 540 may be external buffers. To avoid complex ring buffer management, the first parser 510 may output to the corresponding first parser buffer 530, while the second parser 520 separately outputs to the corresponding second parser buffer 540. To balance performance, the decoder 550 may be designed to be twice as fast as the performance of the parsers 510, 520.

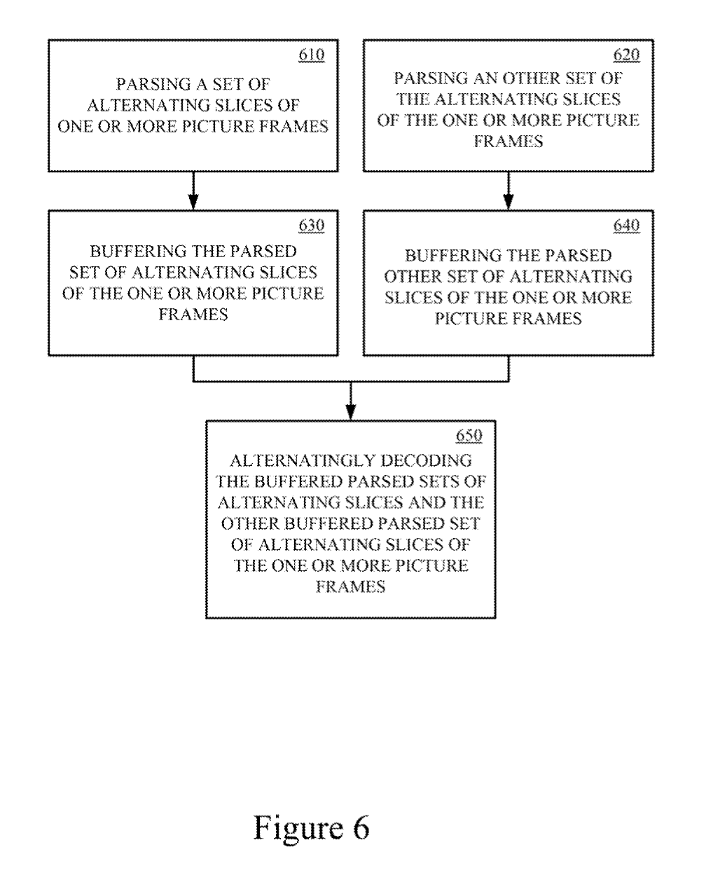

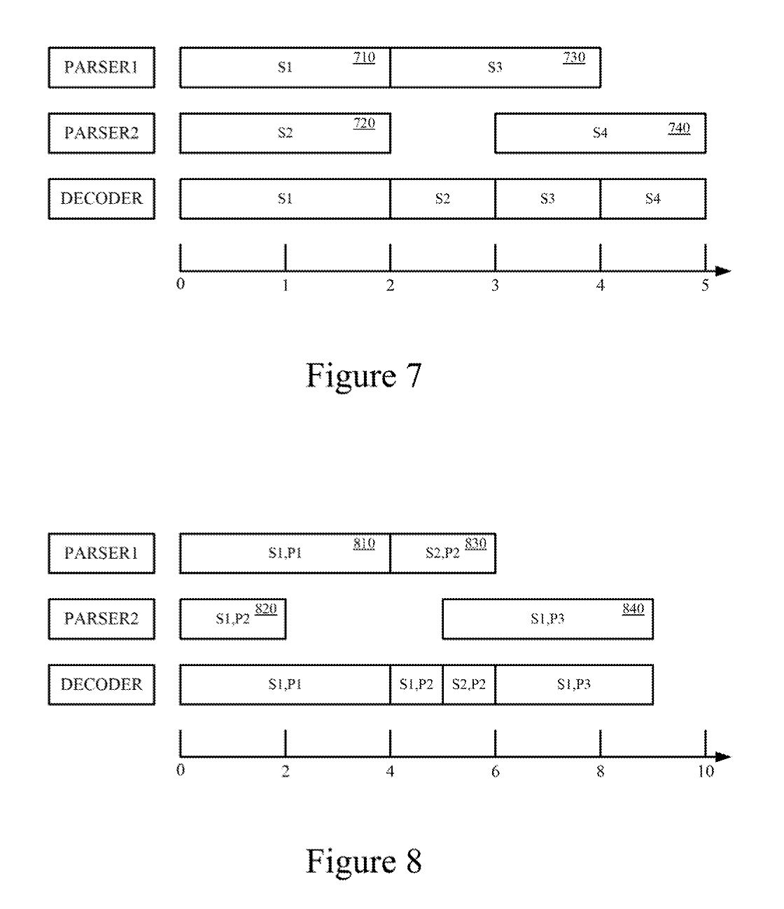

Referring now to FIG. 6, a flow diagram of slice decoding, in accordance with one embodiment of the present technology, is shown. The method may be implemented as computing device-executable instructions (e.g., computer program) that are stored in computing device-readable media e.g., computer memory) and executed by a computing device (e.g., processor). The slice level decoding illustrated in FIGS. 5 and 6 will be further explained with reference to FIGS. 7 and 8. An exemplary schedule of slice level decoding during a picture frame according to the method is illustrated in FIG. 7. While in FIG. 8, an exemplary schedule of slice level decoding among multiple picture frames is illustrated.

The AVC decoder 500 may parse a set of alternating slices of one or more picture frames by a first parser 510, at 610. Substantially in parallel to parsing the set of alternating slices, the other set of alternating slices of the one or more picture frames may be parsed by a second parser 520, at 620. For example, as illustrated in FIG. 7, the first parser 510 may parse a first slice of a picture frame (S1, P1) 710, while the second parser 520 parses a second slice (S2, P1) 720. The first parser 510 may then parse a third slice (S3, P1) 730, while the second parser 520 parses a fourth slice (S4, P1) 740 of the given picture frame. In another example, as illustrated in FIG. 8, a first picture may be comprised of a single slice, a second picture may be comprised of two slices, and a third picture may be comprises of a single slice. The first parser 510 may parse the slice of the first picture (S1, P1) 810. The second parser 520 may parse the first slice of the second picture (S1, P2) 820. The first parser 510 may then parse the second slice of the second picture (S2, P2) 830, while the second parser 520 parses the slice of the third picture (S1, P3) 840.

Each slice of each frame parsed by the first parser 510 is buffered by the first parser buffer 530, at 630. Similarly, each slice of each frame parsed by the second parser 520 is buffered by the second parser buffer 540, at 640. The decoder 550 alternating decodes the slices buffered in the first and second parser buffers 530, 540, at 650. For example, the decoder 550 may decode the first slice of the given picture received in the first parser buffer 530, and then the second slice from the second parser buffer 540. The process is repeated by the decoder to decode the third slice in from the first parser buffer 530 and then the forth slice in the second parser buffer 540 as illustrated in FIG. 7. If a time cost of two (2) units for parsing each slice is incurred, for example, the parsing and decoding can be achieved in approximately five (2) time units as illustrated in FIG. 7.

In the other example illustrated in FIG. 8, the decoder 550 may decode the slice of the first picture frame from the first parser buffer 530, and then a first slice of a second picture frame from the second parser buffer 540. The process is repeated by the decoder to decode the second slice of the second picture from the first parser buffer 530 and then the slice of a third picture from the second parser buffer 540. If a time cost of one (1) unit for decoding each slice is incurred, for example, the parsing and decoding can be achieved in approximately nine (9) time units as illustrated in FIG. 8.

Embodiments of the present technology advantageously improve performance by isolating the data dependency of video decoding. Embodiments advantageously enable substantially parallel parsing of alternating slice of one or more frames of video or audio/video data. The parallel parsing advantageously reduces processing bottle necks in AVC decoders.

The foregoing descriptions of specific embodiments of the present technology have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is intended that the scope of the invention be defined by the claims appended hereto and their equivalents.

What is claimed is:

1. An apparatus comprising:
a plurality of parsers wherein each parser parses a set of alternating slices of one or more frames of audio/video data;
a plurality of parser buffers, wherein each parser buffer buffers the set of alternating slices of the one or more frames of audio/video data from as respective one of the plurality of parsers; and
a decoder that decodes the parsed slices of one or more frames of audio/video data alternatingly from the plurality of parser buffers.

2. The apparatus of claim 1, wherein the decoder comprises a block-oriented motion compensation-based decoder.

3. The apparatus of claim 1, wherein the audio/video data complies with an H.264/MPEG-4 AVC standard.

4. The apparatus of claim 1, wherein each parser comprises a respective entropy decoder (VLD) module.

5. The apparatus of claim 4, wherein each parser further comprises a respective motion vector (MV) module.

6. The apparatus of claim 1, wherein the decoder comprises an inverse quantizing and transform module (IQT), an intra prediction module, and inter prediction module, a reconstruction module and deblocking module.

7. The apparatus of claim 6, wherein the decoder further comprises an MV module.

8. The apparatus of claim 6, wherein the inter prediction module performs motion compensation.

9. A method comprising:
parsing a set of alternating slices of one or more picture frames;
parsing another set of alternating slices of the one or more picture frames;
buffering the parsed set of alternating slices of the one or more picture frames;
buffering the parsed other set of alternating slices of the one or more picture frames; and
decoding the buffered parsed set of alternating slices alternatingly with the other buffered parsed set of alternating slices of the one or more picture frames.

10. The method according to claim 9, wherein the decoding is performed at a rate twice as fast as the parsing.

11. The method according to claim 9, wherein parsing the set of alternation slices is performed substantially in parallel to parsing the other set of alternating slices.

12. One or more computing device readable media storing computing device executable instruction that when executed by a processor perform a method comprising:
parsing a set of alternating slices of one or more picture frames;
parsing an other set of alternating slices of the one or more picture frames, wherein the other set of alternating slices are parsed separately from the set of alternating slices;
buffering the parsed set of alternating slices of the one or more picture frames;
buffering the parsed other set of alternating slices of the one or more picture frames, wherein the parsed other set of alternating slices are buffered separately from the parsed set of alternating slices; and
alternatingly decoding the buffered parsed slices of the one or more picture frames from the buffered parsed set of alternating slices and the buffered parsed other set of alternating slices.

13. The method according to claim 12, wherein the decoding comprises a block-oriented motion compensation-based decoding.

14. The method according to claim 12, wherein the one or more picture frames comprise complies with an H.264/MPEG-4 AVC standard.

15. The method according to claim 12, wherein parsing the set of alternation slices is performed substantially in parallel to parsing the other set of alternating slices.
